(19) United States
(12) Patent Application Publication
(10) Pub. No.: US 2026/0140859 A1
(43) Pub. Date: May 21, 2026

(54) REGRESSION TEST GENERATION FOR EVALUATING SOFTWARE MODIFICATIONS USING GENERATIVE ARTIFICIAL INTELLIGENCE

(71) Applicant: Dell Products L.P., Round Rock, TX (US)

(72) Inventors: Vighneshwar Hegde, Bangalore (IN); Pradeepa KR, Bangalore (IN); Manikandan Sethuraman, Bangalore (IN); Peniel Charles, Bangalore (IN)

(21) Appl. No.: 18/952,172

(22) Filed: Nov. 19, 2024

(51) Int. Cl. G06F 11/36; G06F 8/71

(52) U.S. Cl. CPC G06F 11/3698; G06F 8/71

(57) ABSTRACT

Techniques are provided for regression test generation for evaluating software modifications using generative artificial intelligence (AI). One method comprises obtaining issue tracking data records associated with prior changes to a given software file, wherein the issue tracking data records comprise information characterizing a description of respective changes to the given software file and a respective test environment used to evaluate the respective changes to the given software file; applying the information characterizing the descriptions of the respective changes to the given software file and the respective test environments to at least one generative AI model, wherein the at least one generative AI model predicts at least a portion of a regression test to be performed for an additional change to the given software file; and initiating an automated action based on the at least the portion of the regression test for the additional change to the given software file.

### BACKGROUND

A software deployment pipeline automates a software delivery process, and typically comprises a set of automated processes and tools that allow software developers and an operations team to work together to generate and deploy application software code to a production environment using a software development platform. Software development tasks often employ a software build process to compile the generated software code.

### SUMMARY

Illustrative embodiments of the disclosure provide techniques for regression test generation for evaluating software modifications using generative artificial intelligence (AI). An exemplary method comprises generating one or more first data structures at least in part by parsing a plurality of issue tracking data records, wherein each of the plurality of issue tracking data records is associated with a respective one of a plurality of prior changes to a given software file, wherein the plurality of issue tracking data records comprises information characterizing a description of the respective change to the given software file and a respective test environment used to evaluate the respective change to the given software file; applying at least a portion of the information characterizing the descriptions of the respective changes to the given software file and the respective test environments for the given software file to at least one generative AI model, wherein the at least one generative AI model generates one or more second data structures comprising information characterizing at least a portion of a regression test to be performed for an additional change to the given software file; and initiating at least one automated action based at least in part on the at least the portion of the regression test for the additional change to the given software file.

Illustrative embodiments can provide significant advantages relative to conventional techniques. For example, technical problems associated with updating software using a software development system are mitigated in one or more embodiments by employing one or more generative AI models to predict at least a portion of at least one regression test to evaluate an impact of one or more software file modifications.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for regression test generation for evaluating software modifications using generative AI, in accordance with an illustrative embodiment;

FIG. 2 shows an example of a software development lifecycle in an illustrative embodiment;

FIG. 3 shows an example of at least portions of the software development lifecycle of FIG. 2 in further detail, in accordance with an illustrative embodiment;

FIG. 4 is a flow chart illustrating an exemplary processing of git-based pull requests and an initiation of a regression test suggestion generation process, in accordance with an illustrative embodiment;

FIG. 5 is a flow chart illustrating an exemplary implementation of a regression test suggestion generation process, in accordance with an illustrative embodiment;

FIG. 6 illustrates a generative pre-trained transformer, in accordance with an illustrative embodiment;

FIG. 7 illustrates a representative generative AI model prompt, in accordance with an illustrative embodiment;

FIG. 8 illustrates a representative generative AI model output, in accordance with an illustrative embodiment;

FIG. 9 is a flow diagram illustrating an exemplary implementation of a process for regression test generation for evaluating software modifications using generative AI, in accordance with illustrative embodiments;

FIG. 10 illustrates an exemplary processing platform that may be used to implement at least a portion of one or more embodiments of the disclosure comprising a cloud infrastructure; and

FIG. 11 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for regression test generation for evaluating software modifications using generative AI.

The term DevOps generally refers to a set of practices that combines software development and information technology (IT) operations. DevOps are increasingly being used to shorten the software development lifecycle and to provide continuous integration, continuous delivery, and continuous deployment. Continuous integration (CI) generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment (CD) allows code changes that pass an automated testing phase to be automatically released into the production environment, thus making the changes visible to end users. Such processes are typically executed within a software generation and deployment pipeline.

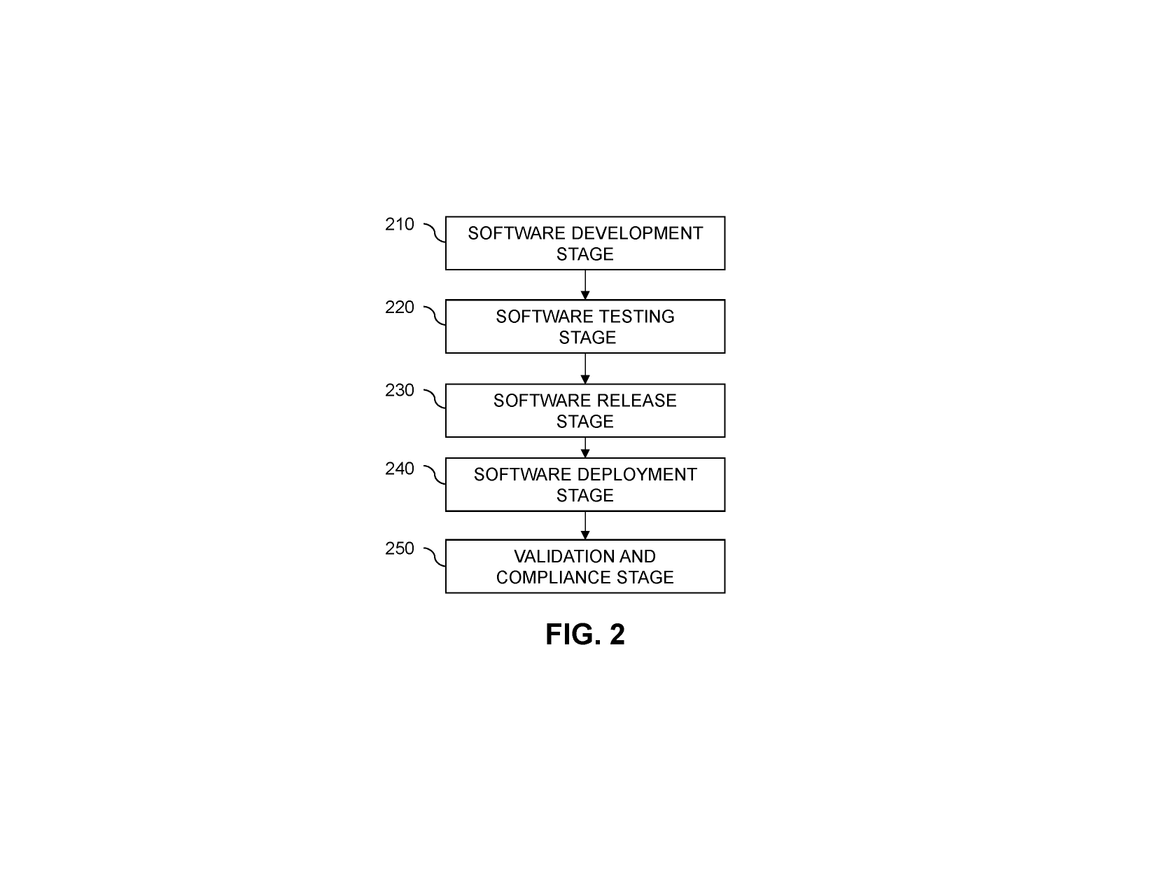

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors and that all unit tests and functional user interface tests must pass.

The term “regression test” as used herein shall be broadly construed to encompass any testing or evaluation of software code changes, such as determining whether such software code changes impair or disrupt existing functionality. A regression test hint, in at least some embodiments, is a suggestion, for example, from one or more developers or another software professional to guide a quality engineering team on what existing features or workflows may be affected by recent software code changes. The regression test suggestions may be obtained, for example, by understanding where software code changes occurred and recalling historical defects that were identified and addressed in the past. One or more aspects of the disclosure recognize that regression testing should not rely solely on a static set of test cases but should be dynamically tailored for each software code modification.

Identifying potential regression testing issues may be challenging even for a skilled developer. In addition, novice software developers may face challenges in identifying historical regression issues due to their limited experience. Furthermore, a lack of a comprehensive understanding of the integration code flow can hinder an ability to provide accurate regression test suggestions. Software professionals may not always be fully aware of a defect history for previous software releases in the same functional area, which can ultimately impact the quality of the regression test suite. Generally, without proper regression test suggestions, the generation of an effective regression test suite becomes a challenging task.

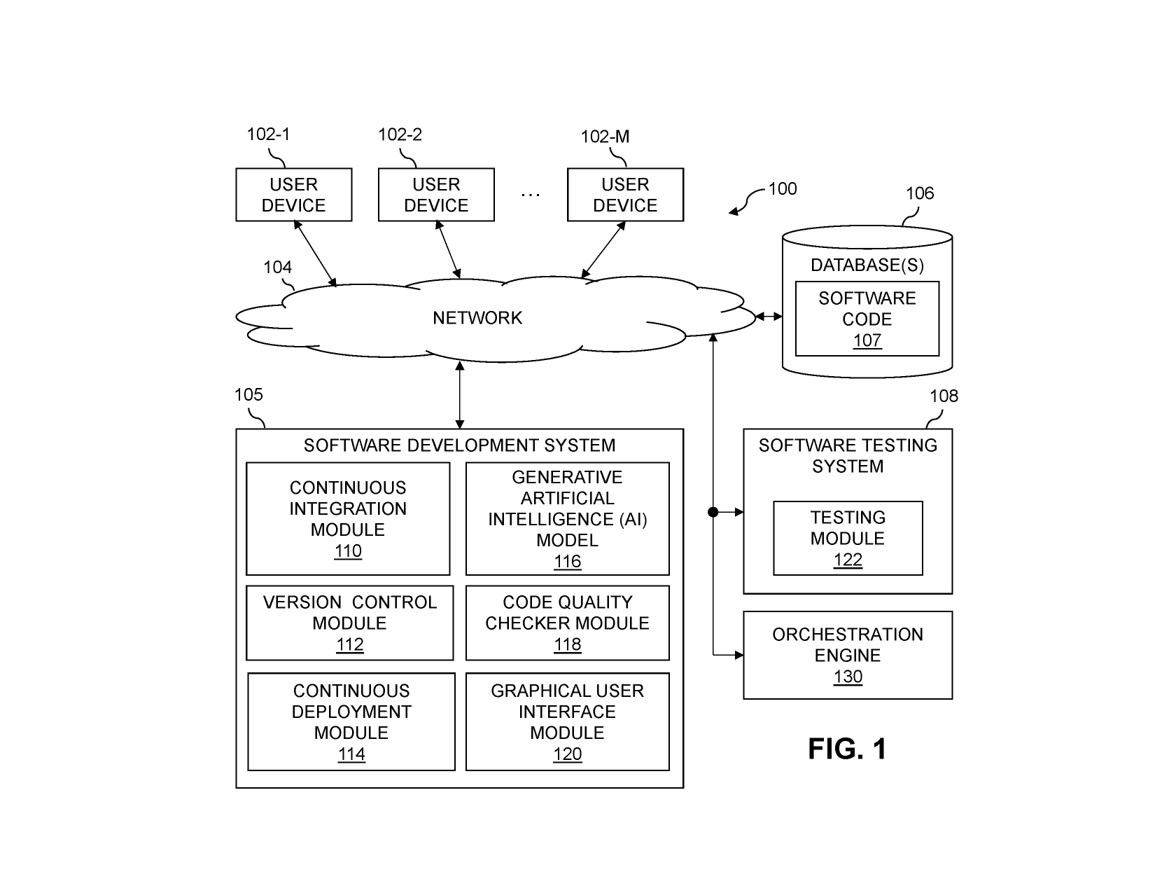

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105, a software testing system 108 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The software development system 105 comprises a continuous integration module 110, a version control module 112, a continuous deployment module 114, a generative AI model 116, a code quality checker module 118 and a graphical user interface (GUI) module 120. Exemplary processes utilizing elements 110, 112, 114, 116, 118 and/or 120 will be described in more detail with reference to, for example, the flow diagrams of FIGS. 2, 4, 5 and 9.

In at least some embodiments, the continuous integration module 110, the version control module 112 and/or the continuous deployment module 114, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. Source code management (SCM) techniques may be used to track modifications to a source code repository. In some embodiments, SCM techniques are employed to track a history of changes to a software code base and to resolve conflicts when merging updates from multiple software developers.

The continuous deployment module 114 manages the automatic release of software code changes made by one or more software developers from a software repository to a production environment, for example, after validating the stages of production have been completed. The continuous deployment module 114 may interact in some embodiments, with the software testing system 108 to coordinate the testing of software code and/or verify a successful testing of software code.

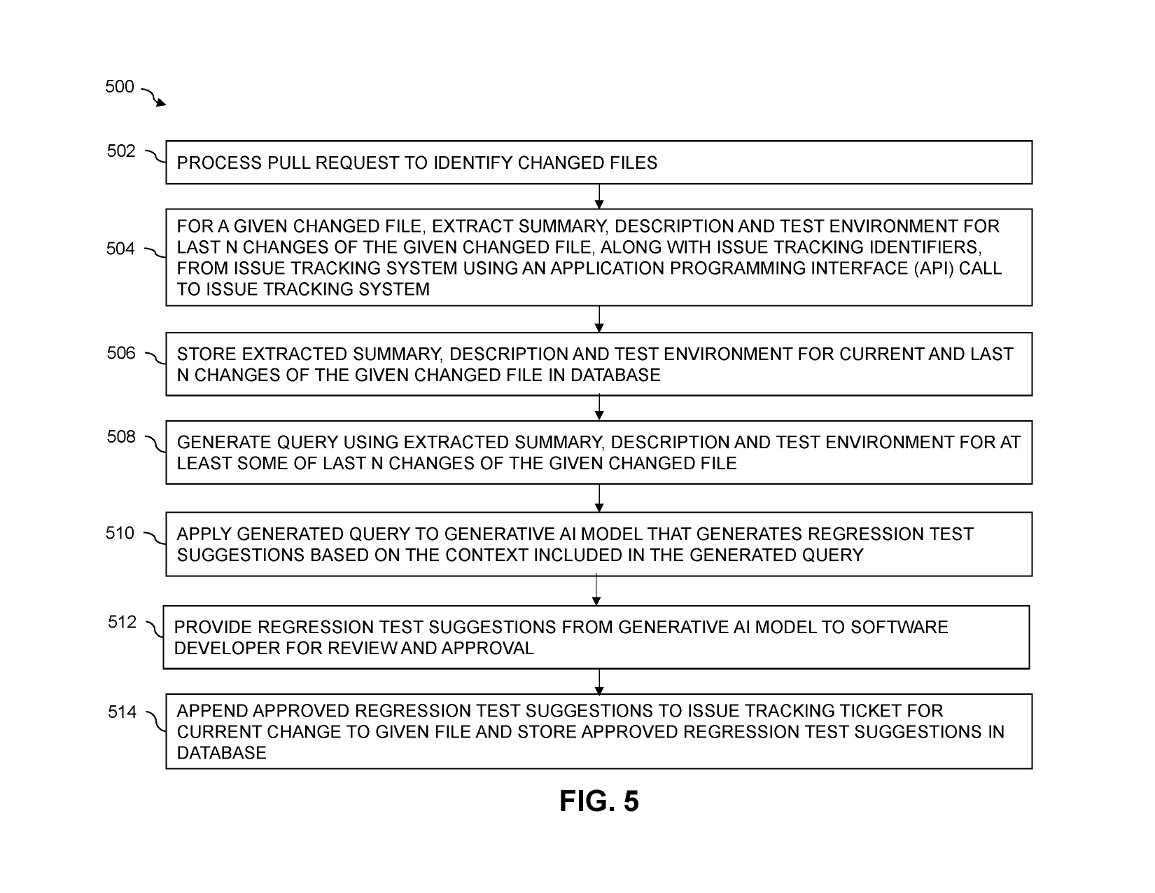

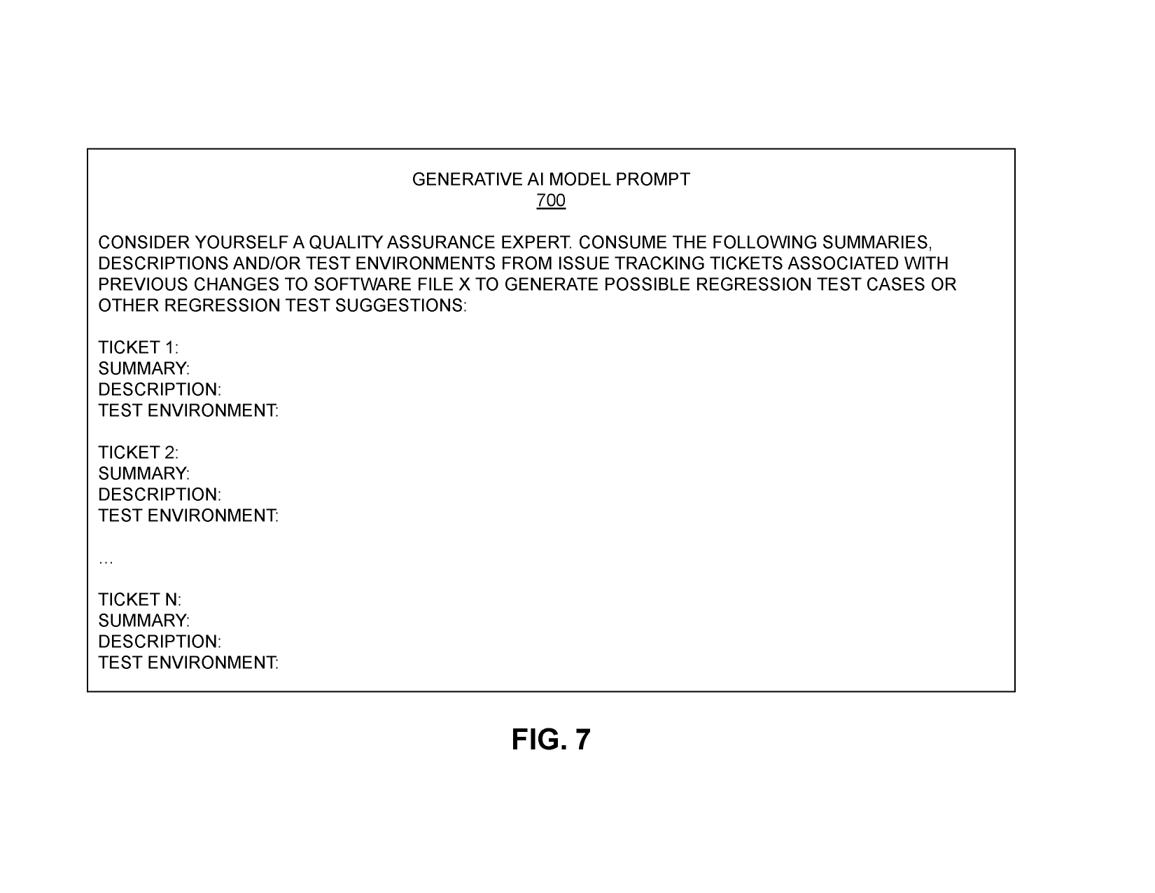

In at least some embodiments, the generative AI model 116 may predict one or more regression tests or portions of such regression tests, as discussed further below in conjunction with, for example, FIGS. 5 and 7, for example. In one or more embodiments, the code quality checker module 118 may include functionality for evaluating, testing and/or debugging one or more software files, as discussed herein. For example, the code quality checker module 118 can administer the disclosed techniques for generative AI-based regression test generation in some embodiments, in addition to existing checkers for application security and code quality, for example.

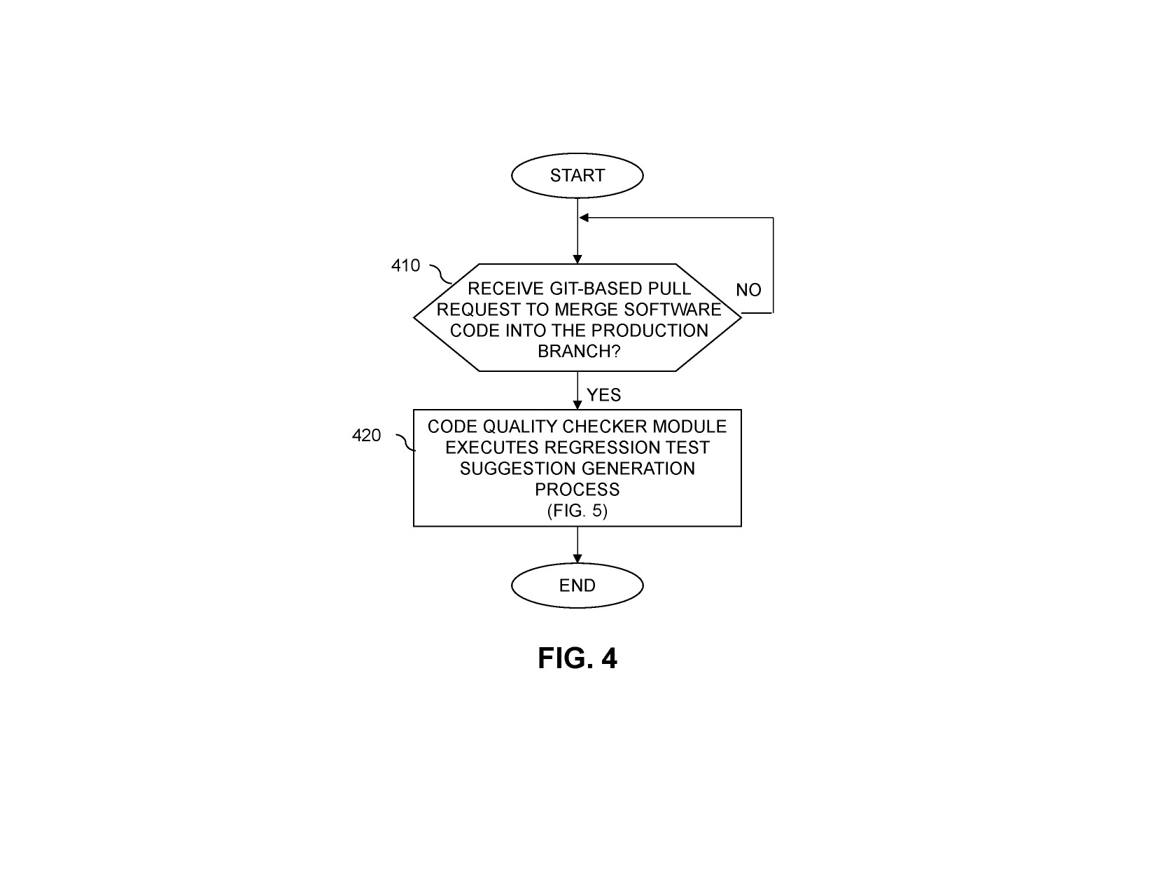

The GUI module 120 may include functionality in some embodiments for the generation and interaction of, for example, regression testing, as discussed further below in conjunction with FIGS. 4 and 5, for example.

It is to be appreciated that this particular arrangement of elements 110, 112, 114, 116, 118 and/or 120 illustrated in the software development system 105 of the FIG. 1 embodiment is presented by way of example only, and alternative arrangements can be used in other embodiments. For example, the functionality associated with the elements 110, 112, 114, 116, 118 and/or 120 in other embodiments can be combined into a single module or separated across a larger number of modules. As another example, multiple distinct processors can be used to implement different ones of the elements 110, 112, 114, 116, 118 and/or 120 or portions thereof.

At least portions of elements 110, 112, 114, 116, 118 and/or 120 may be implemented at least in part in the form of software that is stored in memory and executed by a processor.

The software testing system 108 comprises a testing module 122 that performs one or more software tests within a software deployment pipeline, as would be apparent to a person of ordinary skill in the art. Generally, software testing aims to ensure that bugs and other software code errors are detected as soon as possible and are remedied before being exposed to end-users. In some embodiments, the software testing system 108 performs pipeline-level testing, for example, in a virtualized environment.

It is to be appreciated that this particular arrangement of the testing module 122 illustrated in the software testing system 108 of the FIG. 1 embodiment is presented by way of example only, and alternative arrangements can be used in other embodiments. For example, the functionality associated with testing module 122 in other embodiments can be separated across a larger number of modules and/or multiple distinct processors can be used to implement the functionality associated with testing module 122, or portions thereof.

In at least some embodiments, the orchestration engine 130 may be implemented, at least in part, using the functionality of Kubernetes or variants thereof.

In one or more embodiments, the orchestration engine 130 may create environments using containers that provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute a pipeline job. The Docker open-source containerization platform may be leveraged in some embodiments for building, deploying, and/or managing containerized applications. Docker enables developers to package applications into container-standardized executable components that combine application source code with operating system libraries and dependencies required to run that code in any environment.

Additionally, the software development system 105 and/or the software testing system 108 can have at least one associated database 106 configured to store data pertaining to, for example, software code 107 of at least one application. For example, the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments).

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102, as discussed further below in conjunction with FIG. 5. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105, the software testing system 108 and/or the orchestration engine 130 in the FIG. 1 embodiment are assumed to be implemented using at least one processing device. Each such processing device generally comprises at least one processor and an associated memory, and implements one or more functional modules for controlling certain features of the software development system 105, the software testing system 108 and/or the orchestration engine 130.

More particularly, the software development system 105, the software testing system 108 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105, the software testing system 108 and/or the orchestration engine 130 to communicate over the network 104 with the user devices 102, and illustratively comprises one or more conventional transceivers.

It is to be understood that the particular set of elements shown in FIG. 1 for software development system 105 and the software testing system 108 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105, the software testing system 108 and database(s) 106 can be on and/or part of the same processing platform.

FIG. 2 shows an example of a software development lifecycle in an illustrative embodiment. A software development lifecycle is comprised of a number of stages 210 through 250. In the example of FIG. 2, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

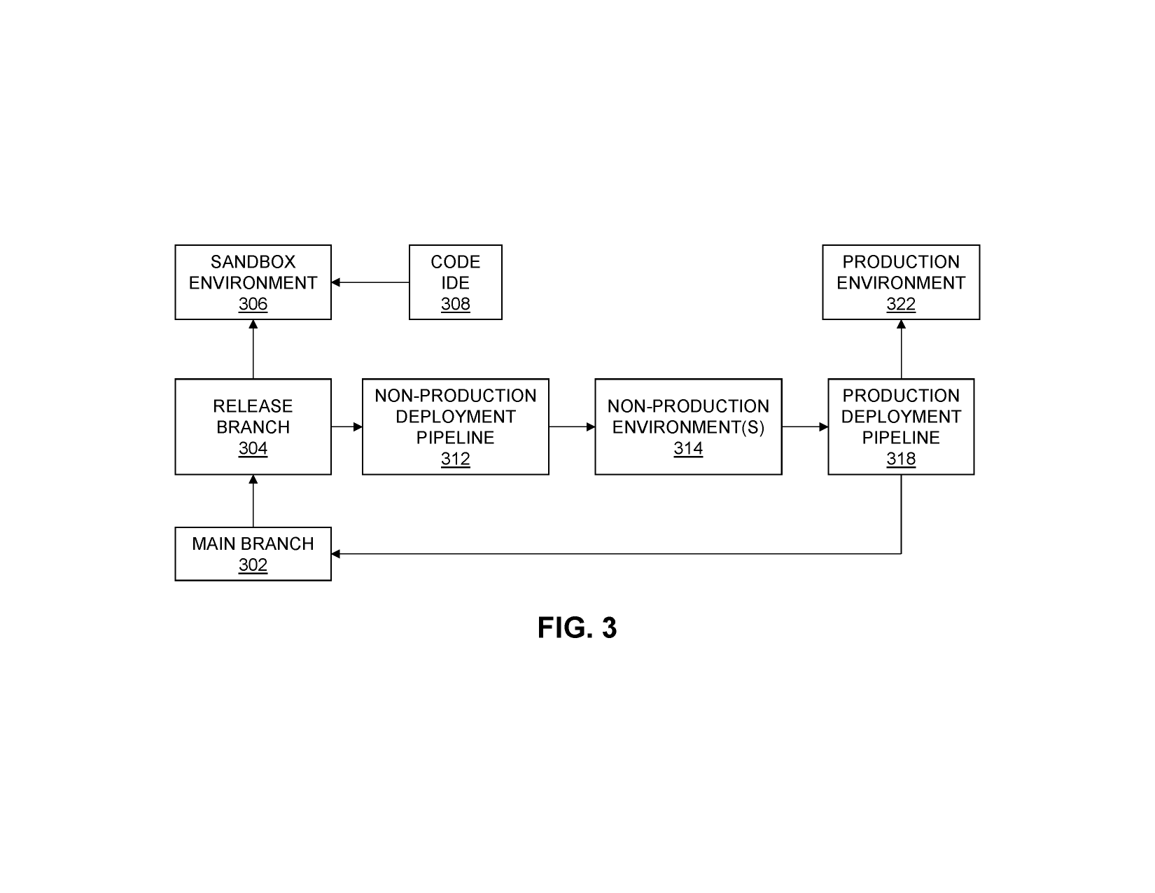

FIG. 3 shows an example of at least portions of the software development lifecycle of FIG. 2 in further detail in an illustrative embodiment. In the FIG. 3 example, a main branch 302 corresponds to software code of at least one software application. A release branch 304 is created based on the main branch 302. For example, the release branch 304 may be created based on development release timelines corresponding to the software application.

One or more developers (e.g., corresponding to user devices 102) create respective personal branches based on the release branch 304, and perform development work using a sandbox environment 306 and a code IDE (integration development environment) 308. Many developers prefer to write software code using such an IDE that allows the software to be developed in any programming language without having to deal with a particular language syntax.

Developers can commit the changes made in their personal branches to the release branch 304. In the FIG. 3 example, a non-production deployment pipeline 312 is triggered according to one or more specified schedules. The non-production deployment pipeline 312 deploys any changes resulting from the change requests to one or more non-production environments 314.

In some examples, the non-production environments 314 may include one or more of: a developer integration testing (DIT) environment, a system integration testing (SIT) environment, and a global environment. As noted above, the non-production deployment pipeline 312 may be triggered according to schedules defined for each of the non-production environments 314 (e.g., a first schedule for a DIT environment and a second schedule for an SIT environment).

A production deployment pipeline 318 can be triggered when the release branch 304 of the application is ready to be deployed to a production environment 322. Generally, the production deployment pipeline 318 collects any changes that were made to the release branch 304, creates a deployment package, and deploys the package to the production environment 322.

FIG. 4 is a flow chart illustrating an exemplary processing of git-based pull requests and an initiation of a regression test suggestion generation process, in accordance with an illustrative embodiment. In the example of FIG. 4,

A test is performed in step 410 to determine if a GIT-based pull request is received to merge software code into a production branch. Step 410 may be implemented, for example, using one or more webhooks. Such a pull request identifies one or more changed software files associated with the GIT-based pull request.

If it is determined in step 410 that a GIT-based pull request has not been received to merge software code into a production branch, then program control returns to step 410 to continue monitoring for such a GIT-based pull request.

If it is determined in step 410 that a GIT-based pull request has been received to merge software code into a production branch, then the code quality checker module (e.g., code quality checker module 118) executes a regression test suggestion generation process in step 420, as discussed further below in conjunction with FIG. 5.

FIG. 5 is a flow chart illustrating an exemplary implementation of a regression test suggestion generation process 500, in accordance with an illustrative embodiment. In the example of FIG. 5, a pull request is processed in step 502 to identify one or more changed files. The number of changed files associated with a given pull request may be obtained, for example, using a Git-based REST API (representational state transfer application programming interface).

In step 504, the process 500 extracts summary, description and test environment information for the last N changes of a given changed file in step 504, along with the corresponding issue tracking identifiers, from an issue tracking system, for example, using an API call to the issue tracking system. The issue tracking system may store and record various code modification information, including regression test information, that is utilized by the regression test suggestion generation process 500. Such information may include, for example, information that is collected regarding historical software file modifications and corresponding regression test scenarios or regression test cases used to evaluate modified software files, where such information may include regression test steps used in the regression test scenarios, machine learning model (e.g., large language model (LLM)) configurations for machine learning models used for generating regression test scenarios (or portions thereof), as well as issues or other defects identified during running regression tests, etc.

One or more aspects of the disclosure recognize that by extracting regression test data from support data records (e.g., tickets) maintained by an issue tracking system, generative AI techniques may be used to refine and create regression test descriptions using such extracted regression test data, with such regression test descriptions being used to create regression test scenarios using an LLM.

The extracted summary, description and test environment information for the current change and last N changes of the given changed file are stored in step 506, for example, in a local storage device. In step 508, the process 500 generates a query or another input using the extracted summary, description and test environment information for at least some of the last N changes of the given changed file. Such an input (e.g., a system prompt) for an LLM may be constructed by collating the extracted summary, description and test environment information, as discussed further below in conjunction with FIG. 7.

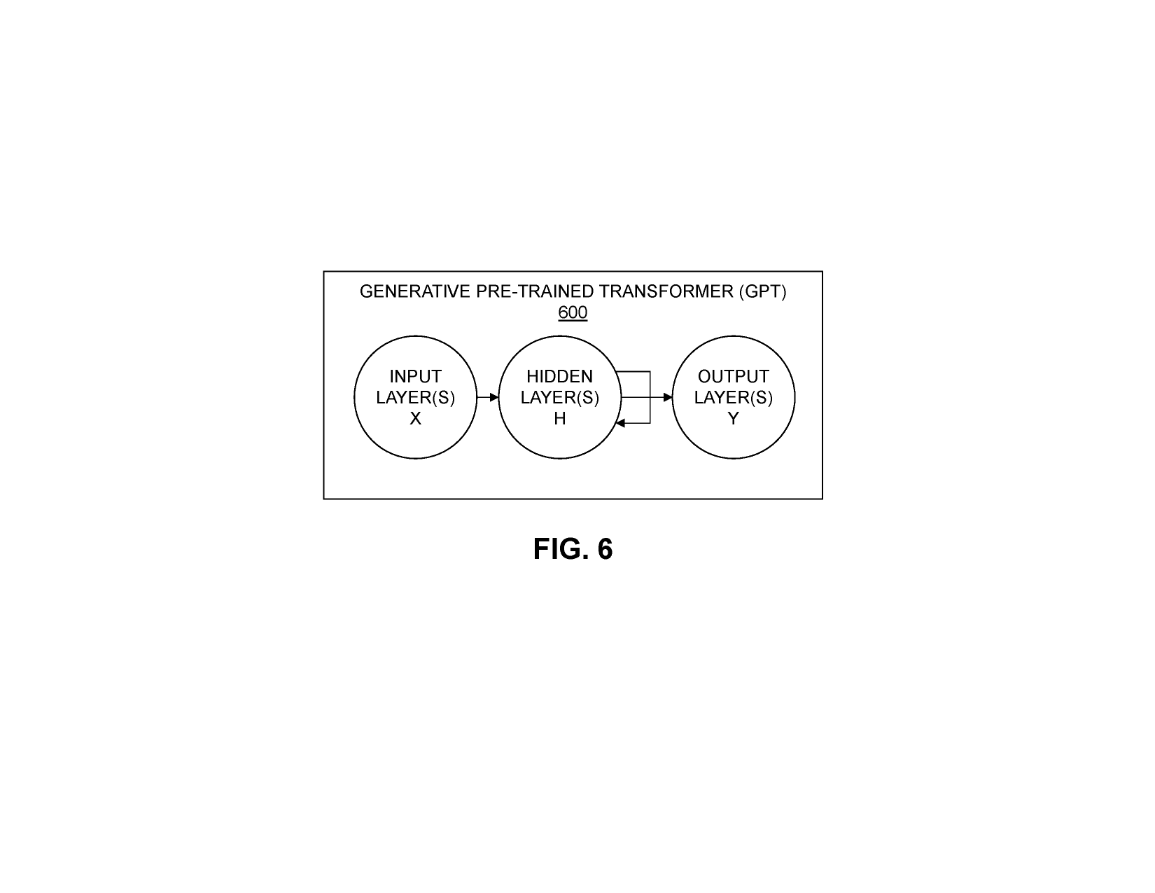

In step 510, the generated query is applied to a generative AI model, as discussed further below in conjunction with FIG. 6, that generates one or more regression test suggestions based at least in part on the context included in the query or input generated in step 508. The generative AI model (e.g., an LLM), on receiving the input, in at least some embodiments, breaks down the input into actionable components, identifying key elements, such as inputs, outputs, and constraints to generate one or more relevant regression test suggestions.

The relevant regression test suggestions generated by the generative AI model are provided in step 512 to a software developer, for example, for review and approval. The software developer may review the regression test suggestions and approve or disapprove one or more of the regression test suggestions, for example, based on a criticality and/or a priority of the regression test suggestions. If the software developer approves one or more of the regression test suggestions, such approved regression test suggestions may be published.

In step 514, the approved regression test suggestions are appended to an issue tracking ticket for the current given file and stored in a database, for example.

FIG. 6 illustrates a generative pre-trained transformer 600 (e.g., a GPT) in an illustrative embodiment. The GPT 600 may be a deep learning language model that is pre-trained on large text corpus and can optionally be fine-tuned using the disclosed generative AI-based regression test generation techniques. In some embodiments, the GPT 600 may be pretrained on the summary, description and test environment information for software code changes to generate response for an applied query or other input, without any customization. The GPT 600 may review information characterizing regression tests performed in past, to predict regression tests, or portions thereof, that should be performed for a current software modification.

In the example of FIG. 6, the GPT 600 comprises an input layer, X, a set of hidden layers, H, and an output layer, Y, in a known manner. It is noted that in some embodiments, multiple GPTs 600 may be employed in parallel.

In at least some embodiments, the input layers, X, provide initial data for the GPT 600, based on a tokenized dataset. The hidden layers, H, between the one or more input layers, X, and the one or more output layers, Y, may process the input information and make connections among the applied tokenized dataset to make predictions. Each neuron in the hidden layer(s) evaluates the tokenized information from the input layer, X, and iteratively finds patterns used for the predictions of the regression test suggestions, using weights to indicate an importance of the inputs and applying them to an activation function or another decision-making process. The output layers, Y, may determine a final prediction by combining information from the hidden layers.

In some embodiments, the GPT 600 is configured to process an input (e.g., a prompt or a query) and to generate one or more portions of a regression test, such as a given sequence of regression test steps for a given regression test scenario configured for regression testing of at least one aspect of modified software code.

FIG. 7 illustrates a representative generative AI model prompt 700, in accordance with an illustrative embodiment. In the example of FIG. 7, the generative AI model prompt 700 instructs the generative AI model to act as a quality assurance expert and to consume provided summaries, descriptions and/or test environments from issue tracking tickets associated with prior modifications to a given software file. The generative AI model prompt 700 comprises information characterizing a summary, a description and a test environment associated with regression testing performed for the N most recent changes to a given software file. As noted above, the provided summaries, descriptions and test environments are extracted, for example, from an issue tracking system.

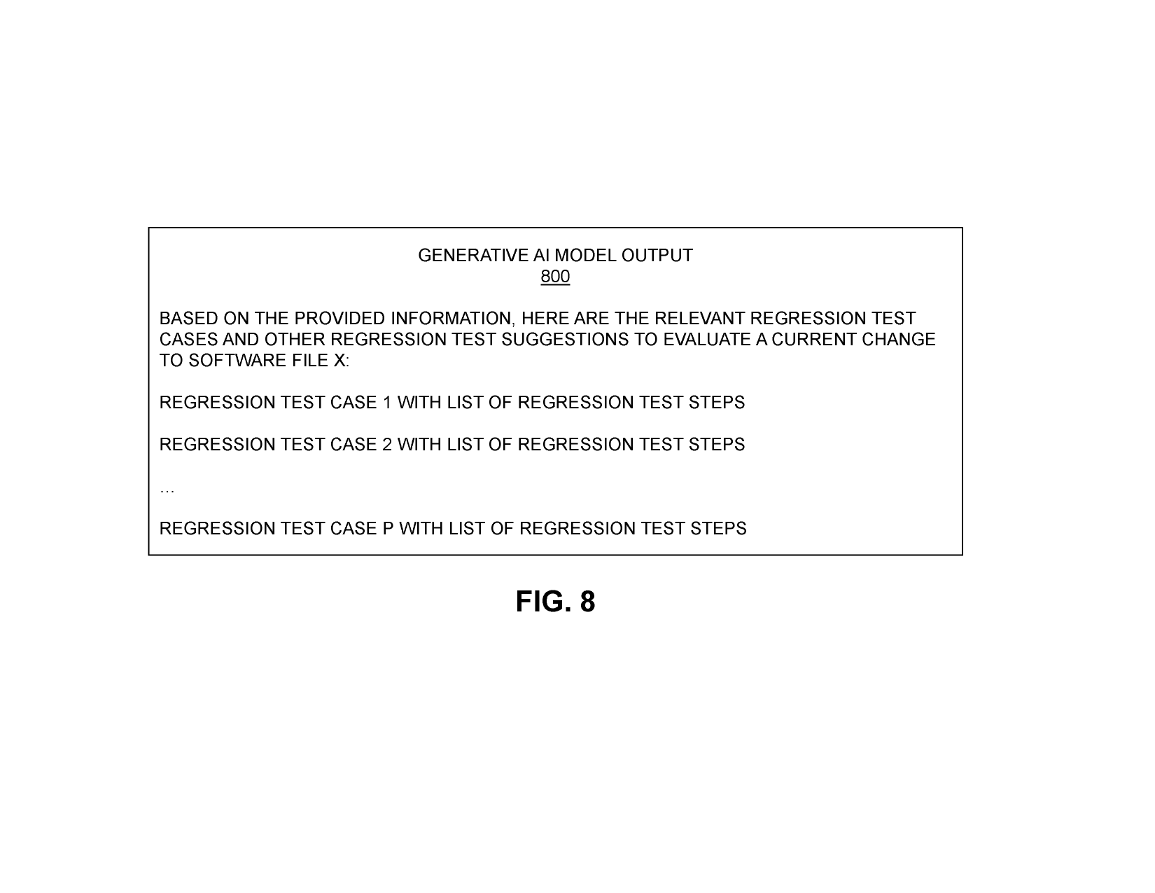

FIG. 8 illustrates a representative generative AI model output 800, in accordance with an illustrative embodiment. In the example of FIG. 8, the generative AI model output 800, generated, for example, by the generative AI model 116, is provided based on the applied information, such as the representative generative AI model prompt 700 of FIG. 7. The generative AI model output 800 may comprise, for example, one or more regression test cases, each with one or more regression test steps.

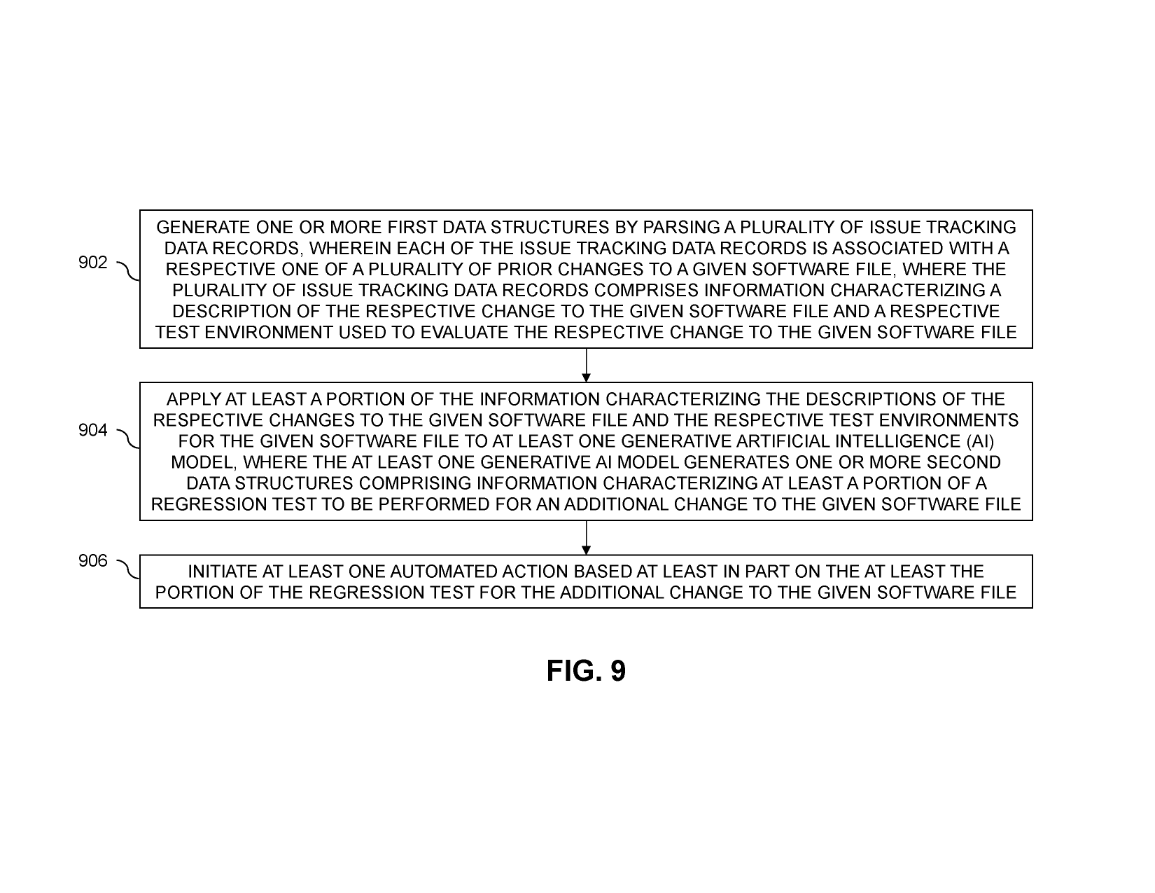

FIG. 9 is a flow diagram illustrating an exemplary implementation of a process for regression test generation for evaluating software modifications using generative AI, in accordance with an illustrative embodiment. In the example of FIG. 9, one or more first data structures are generated at least in part in step 902 by parsing a plurality of issue tracking data records, wherein each of the plurality of issue tracking data records is associated with a respective one of a plurality of prior changes to a given software file, wherein the plurality of issue tracking data records comprises information characterizing a description of the respective change to the given software file and a respective test environment used to evaluate the respective change to the given software file.

It should be noted that the term “data structure” as used herein is intended to be broadly construed to encompass any data element or mechanism for storing information related to changes to a software file, as would be apparent to a person of ordinary skill in the art. A data structure may comprise a portion of a larger data structure, or combinations of multiple smaller data structures. Such data structures may include tables, vectors, embeddings, or various other data structures. In some embodiments, the data structures may be specifically formatted or generated such that they are suitable for use as at least one of an input to and an output from at least one generative AI model. It should be further appreciated that “generating” one or more data structures may encompass, for example, populating an existing or previously created data structure with one or more additional data items. In addition, the term “issue tracking data record” as used herein is intended to be broadly construed to encompass any data record (e.g., a ticket) that stores information related to software changes.

In step 904, at least a portion of the information characterizing the descriptions of the respective changes to the given software file and the respective test environments for the given software file is applied to at least one generative AI model, where the at least one generative AI model generates one or more second data structures comprising information characterizing at least a portion of a regression test to be performed for an additional change to the given software file.

At least one automated action is initiated in step 906 based at least in part on the at least the portion of the regression test for the additional change to the given software file.

In one or more embodiments, the generating may be performed, for example, by a processor-based code quality checker module, in response to a pull request associated with the given software file. The at least one generative AI model may comprise at least one generative pre-trained transformer.

In some embodiments, the process of FIG. 9 may further comprise storing one or more approved versions of the at least the portion of the regression test for the given software file in an issue tracking system or a database. The plurality of prior changes to the given software file may comprise a designated number of prior changes to the given software file.

In at least one embodiment, the at least the portion of the information characterizing the descriptions of the respective changes to the given software file and the respective test environments for the given software file is applied to the at least one generative AI model using one or more of at least one system prompt and at least one query.

The at least one automated action may comprise one or more of generating a notification for approval of the at least the portion of the regression test, generating a regression test based at least in part on the at least the portion of the regression test, executing a regression test based at least in part on the at least the portion of the regression test and causing an action to be performed in another system.

The particular processing operations and other network functionality described in conjunction with FIGS. 2 through 5 and 9, for example, are presented by way of illustrative example only, and should not be construed as limiting the scope of the disclosure in any way. Alternative embodiments can use other types of processing operations to provide functionality for regression test generation for evaluating software modifications using generative AI. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Among other benefits, the disclosed techniques for regression test generation for evaluating software modifications using generative AI provide a mechanism for automatically generating at least portions of regression tests. A generative AI model may review information characterizing regression tests performed for modifications to a given software file in the past, to predict regression tests, or portions thereof, that should be performed for a current modification of the given software file.

It should also be understood that the disclosed techniques for regression test generation for evaluating software modifications using generative AI can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for regression test generation for evaluating software modifications using generative AI may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based generative AI-based regression test generation engine, or portions thereof, are illustratively implemented for use by tenants of such a multi-tenant environment.

Cloud infrastructure as disclosed herein can include cloud-based systems. Virtual machines provided in such systems can be used to implement at least portions of a generative AI-based regression test generation platform in illustrative embodiments. The cloud-based systems can include object stores.

In some embodiments, the cloud infrastructure additionally or alternatively comprises a plurality of containers implemented using container host devices. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

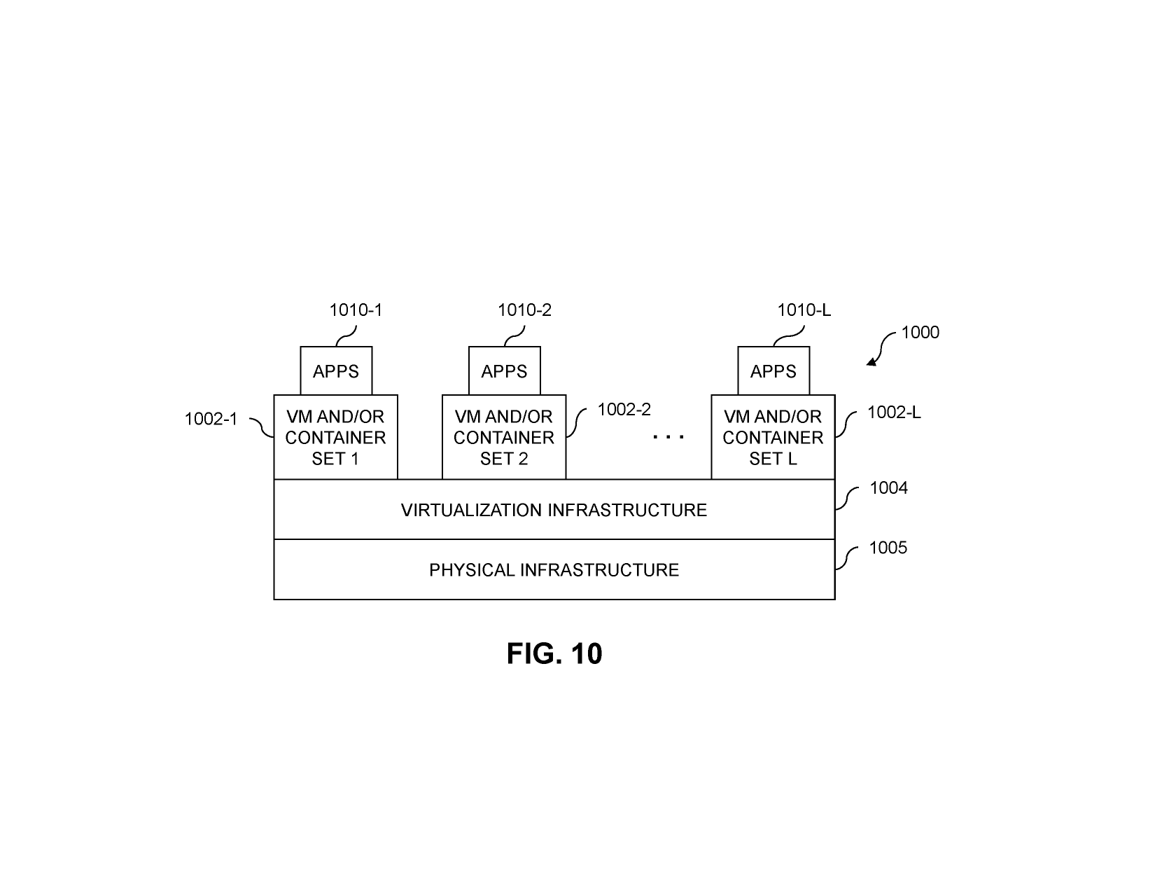

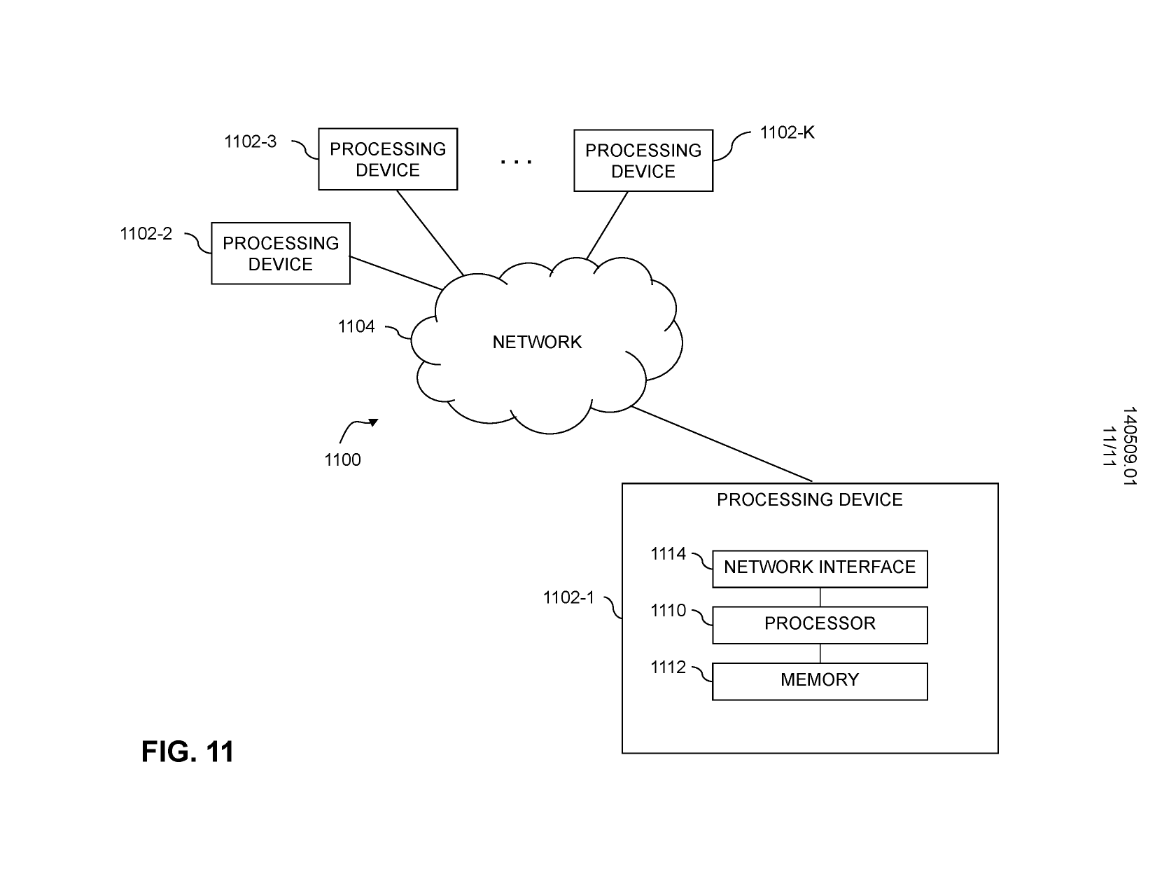

Illustrative embodiments of processing platforms will now be described in greater detail with reference to FIGS. 10 and 11. These platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of an information processing system. The cloud infrastructure 1000 comprises multiple VMs and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. Such implementations can provide generative AI-based regression test generation functionality of the type described above for one or more processes running on a given one of the VMs. For example, each of the VMs can implement generative AI-based regression test generation and associated functionality for generating a system prompt or another input for a generative AI model.

An example of a hypervisor platform that may be used to implement a hypervisor within the virtualization infrastructure 1004 is a compute virtualization platform which may have an associated virtual infrastructure management system such as server management software. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for containers running on bare metal hosts, or containers running on VMs. The containers are illustratively implemented using respective kernel control groups of the operating system. Such implementations can provide generative AI-based regression test generation functionality of the type described above for one or more processes running on different ones of the containers. For example, a container host device supporting multiple containers of one or more container sets can implement one or more instances of generative AI-based regression test generation and associated functionality for generating a system prompt or another input for a generative AI model.

As is apparent from the above, one or more of the processing modules or other components of system may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises at least a portion of the given system and includes a plurality of processing devices, denoted 1102-1, 1102-2, 1102-3, . . . 1102-K, which communicate with one another over a network 1104. The network 1104 may comprise any type of network, such as a WAN, a LAN, a satellite network, a telephone or cable network, a cellular network, a wireless network such as WiFi or WiMAX, or various portions or combinations of these and other types of networks.

The processing device 1102-1 in the processing platform 1100 comprises a processor 1110 coupled to a memory 1112. The processor 1110 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 1112, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIGS. 10 or 11, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide containers.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
generating one or more first data structures at least in part by parsing a plurality of issue tracking data records, wherein each of the plurality of issue tracking data records is associated with a respective one of a plurality of prior changes to a given software file, wherein the plurality of issue tracking data records comprises information characterizing a description of the respective change to the given software file and a respective test environment used to evaluate the respective change to the given software file;
applying at least a portion of the information characterizing the descriptions of the respective changes to the given software file and the respective test environments for the given software file to at least one generative artificial intelligence (AI) model, wherein the at least one generative AI model generates one or more second data structures comprising information characterizing at least a portion of a regression test to be performed for an additional change to the given software file; and
initiating at least one automated action based at least in part on the at least the portion of the regression test for the additional change to the given software file;
wherein the method is performed by at least one processing device comprising a processor coupled to a memory.

2. The method of claim 1, wherein the generating is performed in response to a pull request in a software development system associated with the given software file.

3. The method of claim 1, wherein the at least one generative AI model comprises at least one generative pre-trained transformer.

4. The method of claim 1, wherein the plurality of prior changes to the given software file comprises a designated number of prior changes to the given software file.

5. The method of claim 1, wherein the at least the portion of the information characterizing the descriptions of the respective changes to the given software file and the respective test environments for the given software file is applied to the at least one generative AI model using one or more of at least one system prompt and at least one query.

6. The method of claim 1, wherein the at least one automated action comprises one or more of generating a notification for approval of the at least the portion of the regression test, generating a regression test based at least in part on the at least the portion of the regression test, executing a regression test based at least in part on the at least the portion of the regression test and causing an action to be performed in another system.

7. The method of claim 1, further comprising storing one or more approved versions of the at least the portion of the regression test for the given software file in an issue tracking system or a database.

8. An apparatus comprising:
at least one processing device comprising a processor coupled to a memory;
the at least one processing device being configured to implement the following steps:
generating one or more first data structures at least in part by parsing a plurality of issue tracking data records, wherein each of the plurality of issue tracking data records is associated with a respective one of a plurality of prior changes to a given software file, wherein the plurality of issue tracking data records comprises information characterizing a description of the respective change to the given software file and a respective test environment used to evaluate the respective change to the given software file;
applying at least a portion of the information characterizing the descriptions of the respective changes to the given software file and the respective test environments for the given software file to at least one generative artificial intelligence (AI) model, wherein the at least one generative AI model generates one or more second data structures comprising information characterizing at least a portion of a regression test to be performed for an additional change to the given software file; and
initiating at least one automated action based at least in part on the at least the portion of the regression test for the additional change to the given software file.

9. The apparatus of claim 8, wherein the generating is performed in response to a pull request in a software development system associated with the given software file.

10. The method of claim 8, wherein the at least one generative AI model comprises at least one generative pre-trained transformer.

11. The apparatus of claim 8, wherein the plurality of prior changes to the given software file comprises a designated number of prior changes to the given software file.

12. The apparatus of claim 8, wherein the at least the portion of the information characterizing the descriptions of the respective changes to the given software file and the respective test environments for the given software file is applied to the at least one generative AI model using one or more of at least one system prompt and at least one query.

13. The apparatus of claim 8, wherein the at least one automated action comprises one or more of generating a notification for approval of the at least the portion of the regression test, generating a regression test based at least in part on the at least the portion of the regression test, executing a regression test based at least in part on the at least the portion of the regression test and causing an action to be performed in another system.

14. The apparatus of claim 8, further comprising storing one or more approved versions of the at least the portion of the regression test for the given software file in an issue tracking system or a database.

15. A non-transitory processor-readable storage medium having stored therein program code of one or more software programs, wherein the program code when executed by at least one processing device causes the at least one processing device to perform the following steps:
generating one or more first data structures at least in part by parsing a plurality of issue tracking data records, wherein each of the plurality of issue tracking data records is associated with a respective one of a plurality of prior changes to a given software file, wherein the plurality of issue tracking data records comprises information characterizing a description of the respective change to the given software file and a respective test environment used to evaluate the respective change to the given software file;
applying at least a portion of the information characterizing the descriptions of the respective changes to the given software file and the respective test environments for the given software file to at least one generative artificial intelligence (AI) model, wherein the at least one generative AI model generates one or more second data structures comprising information characterizing at least a portion of a regression test to be performed for an additional change to the given software file; and
initiating at least one automated action based at least in part on the at least the portion of the regression test for the additional change to the given software file.

16. The non-transitory processor-readable storage medium of claim 15, wherein the generating is performed in response to a pull request in a software development system associated with the given software file.

17. The non-transitory processor-readable storage medium of claim 15, wherein the plurality of prior changes to the given software file comprises a designated number of prior changes to the given software file.

18. The non-transitory processor-readable storage medium of claim 15, wherein the at least the portion of the information characterizing the descriptions of the respective changes to the given software file and the respective test environments for the given software file is applied to the at least one generative AI model using one or more of at least one system prompt and at least one query.

19. The non-transitory processor-readable storage medium of claim 15, wherein the at least one automated action comprises one or more of generating a notification for approval of the at least the portion of the regression test, generating a regression test based at least in part on the at least the portion of the regression test, executing a regression test based at least in part on the at least the portion of the regression test and causing an action to be performed in another system.

20. The non-transitory processor-readable storage medium of claim 15, further comprising storing one or more approved versions of the at least the portion of the regression test for the given software file in an issue tracking system or a database.
